(19) United States
(12) Patent Application Publication
(10) Pub. No.: US 2011/0011058 A1
(43) Pub. Date: Jan. 20, 2011

(54) TURBOFAN ENGINE

(75) Inventor: Carsten CLEMEN, Mittenwalde (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/837,685

(22) Filed: Jul. 16, 2010

(30) Foreign Application Priority Data
Jul. 17, 2009 (DE) 10 2009 033 755.5

(51) Int. Cl. F02K 3/06

(52) U.S. Cl. 60/226.1

(57) ABSTRACT

With a turbofan engine the inner sidewall (2) of the bypass duct (3) features, downstream of the flow divider (11), a straight, conically widening form which, downstream of the supports, struts and guide vanes (7), smoothly transits into a circular-arc transition area (22). The form of the engine fairing (1) is adaptable to the shape of the inner sidewall (2), so that the bypass duct (3) has a conically flaring shape. In the interior of the engine, the gearbox (14) and/or other installations are arranged in a space existing between the inner sidewall (2) and a separating wall (4) confining the core-flow duct (5). The conical design of the bypass duct with the circular-arc transition area enables the gearbox and other installations to be arranged in the engine interior and, furthermore, is aeroacoustically and aerodynamically favorable.

This application claims priority to German Patent Application DE102009033755.5 filed Jul. 17, 2009, the entirety of which is incorporated by reference herein.

This invention relates to a turbofan engine including a core-flow duct with compressors, turbines and a combustion chamber arranged therein and, surrounding the core-flow duct, a bypass duct whose inner sidewall adjoining a flow divider splitting the airflow produced by the fan is retained against the engine fairing by supports, struts and guide vanes, and with the engine having a gearbox or further installations.

Turbofan engines are double-flow engines on which the airflow produced by the fan is split into an inner airflow, or core flow, passing on to the compressors, the combustion chamber and the turbines, and an outer airflow or secondary or bypass flow, producing the majority of thrust. The bypass duct provided in the engine for passing on the outer airflow is confined by an inner sidewall and an outer sidewall forming the engine fairing. The two sidewalls are retained relative to each other by supports, struts and guide vanes. The airflow produced by the fan is divided into the inner airflow, or core flow, and the outer airflow, or bypass flow, by way of a flow divider, or splitter, associated with the inner sidewall. The usually essentially linear course of the inner sidewall, or of the bypass duct, in the area of the splitter and the following supports, struts and guide vanes promotes the propagation of sound and is disadvantageous with respect to the sound level produced and the mach number under certain conditions of flight.

Arranged on the outside of the engine casing and driving certain accessories, for example a generator for electric power supply of the aircraft or engine, is an external gearbox which is connected via a radial shaft and an inner gear drive to a drive shaft connected to the turbine. This gearbox arrangement is both complex and unfavorable in terms of in-flight aerodynamic drag. Moreover, the layout of the bypass duct can be constrained by components to be provided on the engine, for example a large low-pressure turbine or a thrust reverser or an inner gear drive, as a result of which high pressure losses are incurred and the required subsonic mach number (<1) is not attained at flight conditions with high bypass duct mass flow.

In a broad aspect the present invention provides for a design of a turbofan engine with a core-flow duct and a bypass duct and installations provided on the engine by way of which aerodynamically and aeroacoustically favorable conditions are attained in the area of the bypass duct.

For a turbofan engine of the type specified at the beginning above, the basic idea of the present invention is that an inner sidewall of the bypass duct features, downstream of the flow divider, a straight, conically widening form which, downstream of the supports, struts and guide vanes, smoothly transits into a circular-arc transition area. The form of the engine fairing is adapted to the shape of the inner sidewall, so that the bypass duct has a conically flaring shape. In the interior of the engine, the gearbox and/or other installations are arranged in a space existing between the inner sidewall and a separating wall confining the core-flow duct. The conical design of the bypass duct with the circular-arc transition area enables the gearbox and other installations to be arranged in the engine interior and, furthermore, is aeroacoustically and aerodynamically favorable.

In a further embodiment of the present invention, the gradient of the inner sidewall lies in a range of angulation between 20° and 30°.

In another embodiment of the present invention, the radius of the circular-arc transition area, in dependence on the respective angulation of the inner sidewall and, thus, the distance of the foot point and the highest point of the inner sidewall from the engine axis, results in r_{20°}≧0.5×distance for an angle of 20°, and in r_{30°}≦1.5×distance for an angle of 30°, and in a value thereinbetween for a gradient between 20 and 30°.

In a further development of the present invention, the inner sidewall has, between the foot point and the highest point, a length which depends on the radial extension of the engine, whereby at least one partial section of the inner sidewall originating at the foot point ascends in a straight and linear manner with a certain length, and the area adjoining up to the transition area may have a different form.

The starting point, or foot point, of the linearly ascending area of the inner sidewall lies in an area between the tip of the flow divider and the leading edge of the guide vanes or struts arranged in the bypass duct.

An example of the present invention is more fully described in light of the accompanying drawings. In the drawings,

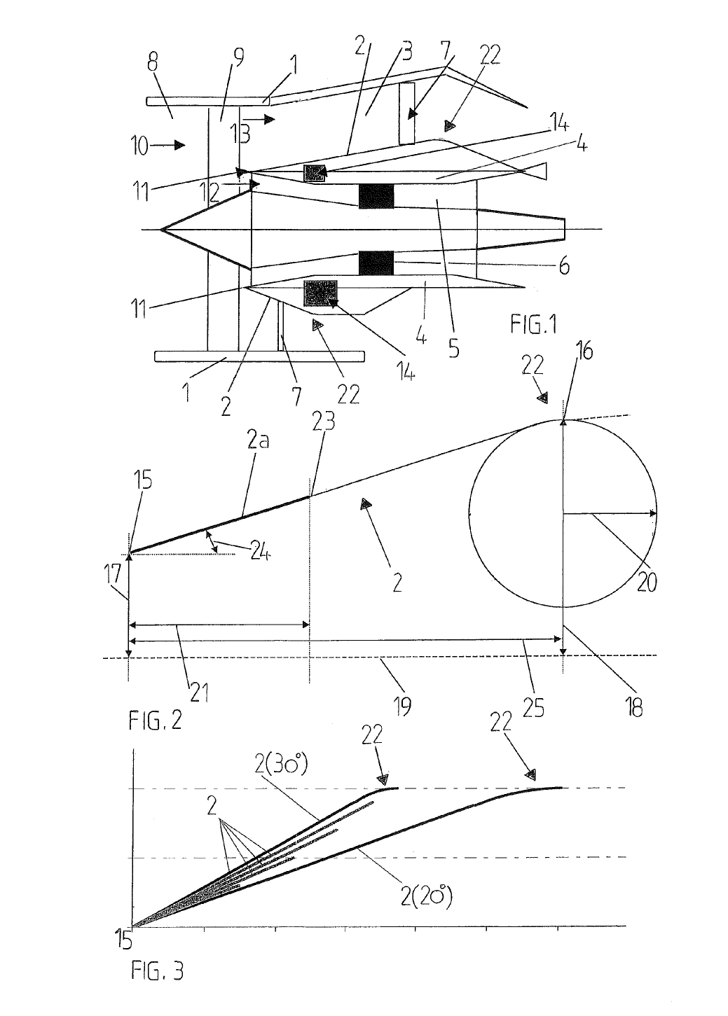

FIG. 1 shows a highly simplified schematic representation of a turbofan engine in two different variants of the engine fairing and the shaping of the bypass duct as well as the arrangement of installations on the core-flow duct,

FIG. 2 provides a graphical definition of the quantities for the determination of the form of the inner sidewall of the bypass duct, and

FIG. 3 is a graphical representation of the form of the inner sidewall of the bypass duct in different length and angulation.

The turbofan engine schematically shown in FIG. 1 includes an engine fairing 1 and an inner sidewall 2 forming a bypass duct 3 as well as an inner separating wall 4 outwardly confining the core-flow duct 5. Arranged in the core-flow duct 5 are compressors, turbines and a combustion chamber, which are here represented only schematically by reference numeral 6. The engine fairing 1 and the inner sidewall 2 are retained against each other by struts, supports and guide vanes 7 situated in the bypass duct 3. An airflow 10 entering the engine via an inlet 8 and a fan 9 is, downstream of the fan 9, divided into a core flow 12 and a bypass flow 13 by means of a flow divider (splitter) 11 at which the inner sidewall 2 and the inner separating wall 4 originate. The inner sidewall 2 of the bypass duct 3 has—starting at the flow divider 11—a straight, flaring, i.e. conically widening form extending at least as far as downstream of the struts, supports and guide vanes 7, by way of which the required space is provided between the core-flow duct 5 and the bypass duct 3 for the arrangement of installations 14 on the core-flow duct 5 in the interior of the engine which are usually mounted on the engine exterior, here a gearbox connected to an engine shaft. Correspondingly conically widening is also the shape of the engine fairing 1, i.e. the outer sidewall of the bypass duct 3.

FIG. 2 shows the form of the inner sidewall 2 of the bypass duct 3 which has a starting point, or foot point, 15 and a highest point 16 whose respective distances 17 or 18 from the engine axis 19 are freely selectable. The foot point 15 of the inner sidewall 2 is in any case situated in an area between the tip (splitter nose) of the flow divider 11 and the leading edge of the guide vanes 7 of the outlet guide vane assembly (OGV), and the gradient of the sidewall 2 lies in a range of angulation 24 between 20° and 30° relative to the engine axis 19. At its highest point 16, from which on the inner sidewall 2 extends again straightly or decreases in diameter, the form of the inner sidewall 2 is controlled by a radius 20 sized such that the corresponding circularity of the sidewall 2 transits smoothly into the straightly extending portion of the sidewall. With the inner sidewall 2 extending from the foot point 15 to the highest point 16 at an angulation 24 between 20 and 30° and the distance 18 between the highest point 16 and the engine axis 19 varying correspondingly, the radius 20 in the transition area 22 between the conically extending sidewall 2 and the further form of the duct results in r_{20°}≧0.5×distance 18, or r_{30°}≦1.5×distance 18, or a value between r_{20°} and r_{30°} corresponding to the angle between 20° and 30°, respectively. Reference numeral 21 indicates the length originating at the foot point 15, or the area of the inner sidewall 2, in which the form of the inner sidewall 2 is in any case linear and between 20° and 30°. This linear area can terminate in the transition area 22 with the radius 20, but can also be shorter, with the part of the sidewall 2 situated between the end 23 of the linear area 2a and the transition area 22 being optionally conceivable. The length 25 of the sidewall between the foot point 15 and the highest point 16 depends on the radial extension, i.e. the distance between the engine axis and the highest point 16, in correspondence with the requirements applicable to the engine. FIG. 3 shows examples of the linear form of the inner sidewall 2 of the bypass duct for different length 25 and different angular position 24.

The bypass duct 3 conceived in accordance with the above example provides for the arrangement on the core-flow duct of installations normally mounted externally on the engine, for example the gearbox, while satisfying high aerodynamic and aeroacoustic requirements.

### LIST OF REFERENCE NUMERALS

1 Engine fairing

2 Inner sidewall of 3

3 Bypass duct

4 Separating wall of 5

5 Core-flow duct

6 Compressor/turbine/combustion chamber

7 Guide vanes, struts, supports

8 Inlet

9 Fan

10 Airflow

11 Flow divider (splitter)

12 Core flow

13 Bypass flow

14 Gearbox/other installations

15 Foot point of 2

16 Highest point of 2

17 Distance between 15 and 19

18 Distance between 16 and 19

19 Engine axis

20 Radius in transition area

21 Length of linear area of 2

22 Transition area

23 End of linear area 2a

24 Range of angulation, angular position of 2

25 Length of sidewall between 15 and 16

What is claimed is:

1. A turbofan engine comprising:
an engine fairing;
a fan;
a core-flow duct;
at least one compressor;
a combustion chamber;
at least one turbine;
at least one of a gearbox and a further installation; and
a bypass duct surrounding the core-flow duct, the bypass duct having an inner sidewall adjoining a flow divider splitting the airflow produced by the fan, the inner sidewall retained against the engine fairing by supports, struts and guide vanes, the inner sidewall including, downstream of the flow divider, a straight, conically widening form which, downstream of the supports, struts and guide vanes, smoothly transits into a circular-arc transition area, with a form of the engine fairing being adapted to a shape of the inner sidewall, and with the at least one of the gearbox and further installation being arranged in an interior of the engine in a space existing between the inner sidewall and a separating wall confining the core-flow duct.

2. The turbofan engine of claim 1, wherein a gradient of the inner sidewall lies in a range of angulation between 20° and 30°.

3. The turbofan engine of claim 2, wherein a radius of the circular-arc transition area, in dependence on a respective angulation of the inner sidewall and, thus, a distance of a foot point and a highest point of the inner sidewall from an engine axis, results in a value in a range of r_{20°}≧0.5×distance, to r_{30°}≦1.5×distance, inclusive.

4. The turbofan engine of claim 1, wherein the inner sidewall has, between a foot point and a highest point, a length which depends on a radial extension of the engine, whereby at least one section of the inner sidewall originating at the foot point ascends straightly and linearly with a certain length, and an area adjoining up to a transition area can have a different form.

5. The turbofan engine of claim 1, wherein a foot point of a linearly ascending area of the inner sidewall lies in an area between a tip of the flow divider and a leading edge of at least one of the guide vanes and struts arranged in the bypass duct.
